(19) United States
(12) Patent Application Publication
(10) Pub. No.: US 2026/0008276 A1
(43) Pub. Date: Jan. 8, 2026

(54) INKJET RECORDING APPARATUS

(71) Applicant: KYOCERA Document Solutions Inc., Osaka (JP)

(72) Inventor: Hiroaki TAKAI, Osaka-shi (JP)

(73) Assignee: KYOCERA Document Solutions Inc., Osaka (JP)

(21) Appl. No.: 19/243,633

(22) Filed: Jun. 19, 2025

(30) Foreign Application Priority Data
Jul. 2, 2024 (JP) 2024-106787

(51) Int. Cl. B41J 11/00; B41J 11/44

(52) U.S. Cl. CPC B41J 11/007; B41J 11/44

(57) ABSTRACT

An inkjet recording apparatus includes a conveying unit and an inkjet head. The conveying unit attracts a sheet to an endless conveyance belt and conveys the sheet. Then inkjet head faces the conveyance belt. The conveyance belt has slits facing end portions of the sheet of a predetermined size in a width direction crossing the conveyance direction. The conveying unit includes an absorber for absorbing ink in a space inside the conveyance belt.

### INCORPORATION BY REFERENCE

This application is based on and claims the benefit of priority from Japanese patent application No.2024-106787 filed on Jul. 2, 2024 which is incorporated by reference in its entirety.

### TECHNICAL FIELD

The present disclosure relates to an inkjet recording apparatus.

### BACKGROUND

A technique for printing an image slightly larger than a sheet so as not to form a margin around the image, so called a borderless printing, is known. However, in this case, there is a problem that the periphery of the sheet is contaminated. Therefore, a technique for suppressing the contamination of the periphery of the sheet in the borderless printing has been studied. For example, there is a case where a sheet having a larger size than the sheet to be printed is superposed on the sheet to be printed. In addition, in some cases, a conveyance belt is provided with a recess in which ink ejected to the outside of the sheet is received.

However, when the printing is performed with the sheet superposed on the sheet to be printed, there is a problem that the consumption of the sheets increases. When the recess is provided in the conveyance belt, since a device for recovering the ink from the recess is provided, the configuration becomes complicated. Further, in order to provide the recess, it is necessary to make the conveyance belt thick, and there is a problem that the uneven thickness tends to cause a variation in the speed.

### SUMMARY

An inkjet recording apparatus includes a conveying unit and an inkjet head. The conveying unit attracts a sheet to an endless conveyance belt and conveys the sheet. Then inkjet head faces the conveyance belt. The conveyance belt has slits facing end portions of the sheet of a predetermined size in a width direction crossing the conveyance direction. The conveying unit includes an absorber for absorbing ink in a space inside the conveyance belt.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal structure of an inkjet recording apparatus according to one embodiment of the present disclosure.

FIG. 2 is a perspective view showing a conveying unit according to the embodiment of the present disclosure.

FIG. 3 is a plan view showing a slit of a conveyance belt according to the embodiment of the present disclosure.

FIG. 4 is a cross-sectional view showing the conveying unit according to the embodiment of the present disclosure.

FIG. 5 is a perspective view showing a cross section of the conveying unit according to the embodiment of the present disclosure.

### DETAILED DESCRIPTION

Hereinafter, with reference to the drawings, an inkjet recording apparatus 1 according to one embodiment of the present disclosure will be described.

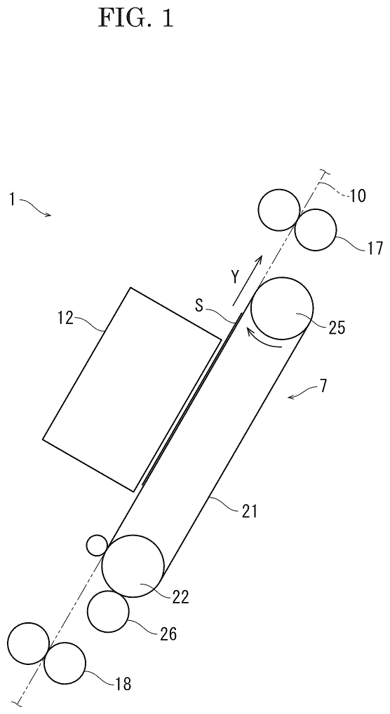

FIG. 1 is a front view schematically showing the internal structure of the inkjet recording apparatus 1. The inkjet recording apparatus 1 includes a conveying unit 7 and an inkjet head 12. The conveying unit 7 includes a conveyance belt 21, a driving roller 25, a driven roller 22, and a charging device 26. The conveyance belt 21 is an endless belt made of insulating resin or the like. The conveyance belt 21 is wound around the driving roller 25 and the driven roller 22. The charging device 26 is in contact with the conveyance belt 21. The charging device 26 is, for example, a roller for applying a voltage. In the present embodiment, the conveying unit 7 is disposed in an inclined manner, but the conveying unit 7 may be disposed horizontally. The left surface of the left portion of the conveyance belt 21 in FIG. 1 forms a part of a conveyance path 10. When the driving roller 25 is driven in the clockwise direction in FIG. 1, the conveyance belt 21 travels in the clockwise direction, and the sheet S is conveyed in the Y direction along the conveyance path 10.

The inkjet head 12 is provided on the left side of the conveying unit 7. The inkjet head 12 ejects ink in accordance with image data. The inkjet head 12 is also inclined in the same manner as the conveying unit 7, and ejects the ink in a direction perpendicular to the sheet S on the conveyance belt 21. A registration roller 18 is provided on the upstream side of the conveying unit 7 in the conveyance direction Y. A conveying roller 17 is provided on the downstream side of the conveying unit 7 in the conveyance direction Y.

The basic operation of the inkjet recording apparatus 1 is as follows. When an image forming job is input to the inkjet recording apparatus 1, the sheet S is fed from the sheet feeding cassette (not shown) to the conveyance path 10, the skew of the sheet S is corrected by the registration roller 18, and the sheet S is conveyed to the conveying unit 7 at a timing corresponding to the image data. The inkjet head 12 ejects the ink to the sheet S conveyed in the Y direction by the conveying unit 7. The sheet S is conveyed by the conveying roller 17 and discharged to a discharge tray (not shown).

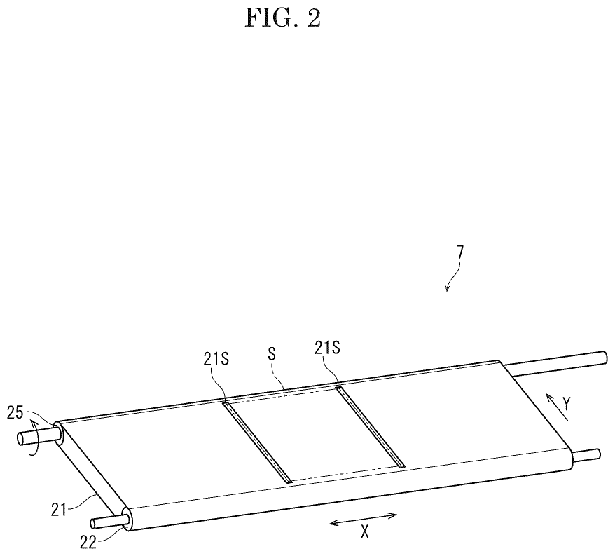

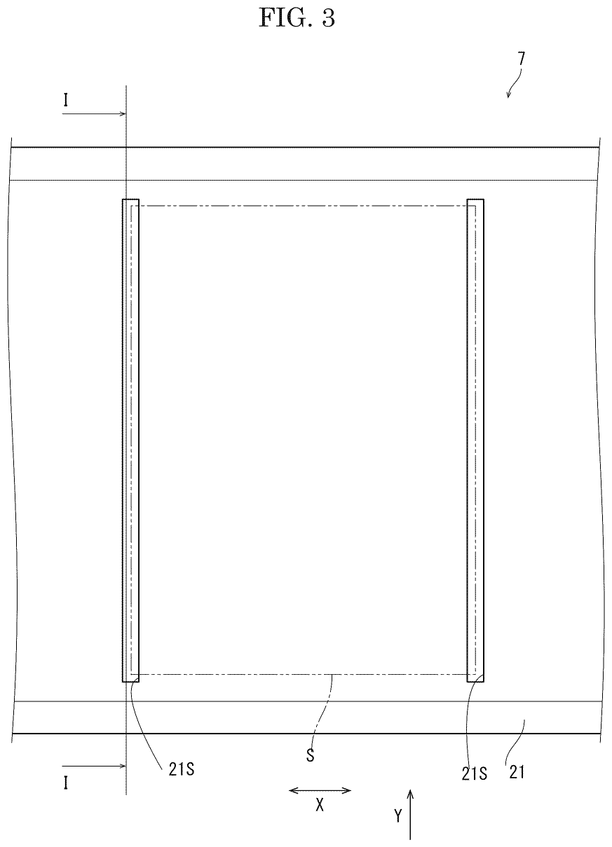

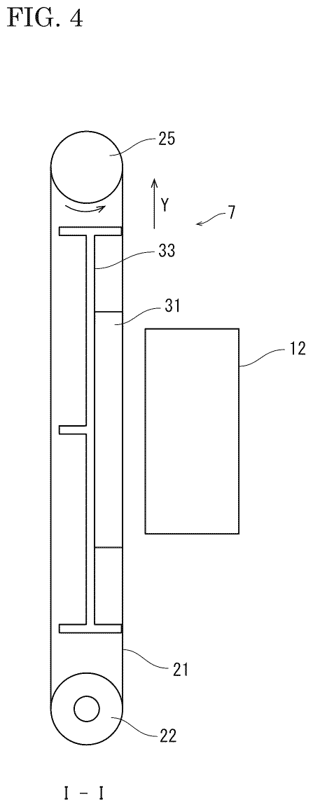

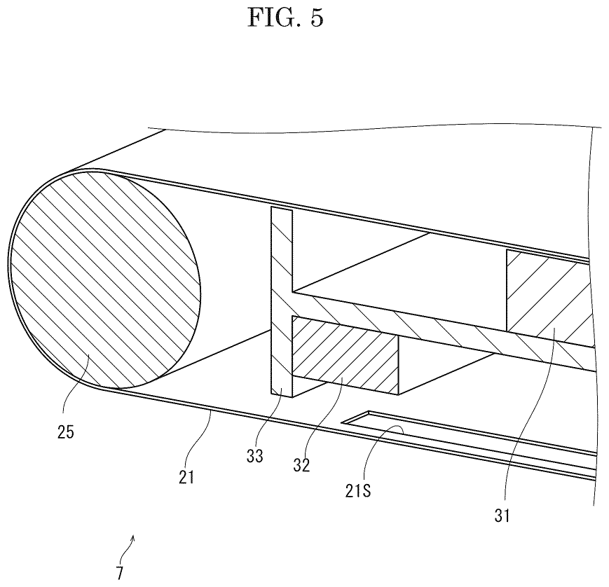

FIG. 2 is a perspective view showing the conveying unit 7. FIG. 3 is a plan view showing a slit 21S of the conveyance belt 21. FIG. 4 is a cross-sectional view showing the conveying unit 7. FIG. 5 is a perspective view showing a cross section of the conveying unit 7.

The conveyance belt 21 includes slits 21S facing the end portions of the sheet S of a predetermined size in the width direction X crossing the conveyance direction Y. The predetermined size is, for example, the L size of a photograph. A length of the slit 21S is equal to or greater than a length of the sheet S of the predetermined size in the conveyance direction Y. Specifically, the length is obtained by adding a few millimeters to the length of the sheet S of the predetermined size in the conveyance direction Y. The slits 21S are continuous over a range longer than the length of the sheet S of the predetermined size in the conveyance direction Y. In order to suppress contamination of the conveyance belt 21, it is advantageous that the slits 21S are continuous, but when durability of the conveyance belt 21 is emphasized, a plurality of slits 21S shorter than the length of the sheet S of the predetermined size in the conveyance direction Y may be arranged in the conveyance direction Y.

The conveying unit 7 includes an absorber 31 (see FIG. 4 and FIG. 5) for absorbing the ink. The absorber 31 is, for example, a sponge or a nonwoven fabric. A frame body 33 is provided in a space inside the conveyance belt 21, and the absorber 31 is attached to the frame body 33. The absorber 31 faces at least a part of the slits 21S. It is desirable that the absorber 31 faces the entire area of the slits 21S. The absorber 31 is detachably provided on the frame body 33 and can be replaced when the absorptive power is reduced.

The conveying unit 7 includes a detection device 32 for detecting a phase of the slits 21S when the conveyance belt 21 is traveled. Specifically, the detection device 32 is an optical sensor, and is attached to the frame body 33. The detection device 32 faces the inner surface of the conveyance belt 21, and detects the slit 21S passing when the conveyance belt 21 is traveled.

The registration roller 18 feeds the sheet S to the conveyance belt 21 in accordance with the phase of the slits 21S detected by the detection device 32. Specifically, the registration roller 18 feeds the sheet S at a timing in which the downstream end of the sheet S in the conveyance direction Y is positioned slightly upstream of the downstream end of the slits 21S in the conveyance direction Y, and the upstream end of the sheet S in the conveyance direction Y is positioned slightly downstream of the upstream end of the slits 21S in the conveyance direction Y. With this configuration, the end portions of the sheet S attracted to the conveyance belt 21 in the width direction X faces the slits 21S over the entire area.

When borderless printing is performed, the inkjet head 12 ejects the ink to a region slightly wider than the four sides of the sheet S. In this case, since the ink ejected to the outside of the end portion of the sheet S in the width direction X passes through the slits 21S, and is absorbed by the absorber 31, contamination of the conveyance belt 21 can be suppressed.

Further, when the slits 21S are formed in the conveyance belt 21, a thickness of the conveyance belt 21 can be made thinner than that in the case where the recess is formed, so that a variation in the conveying speed hardly occur.

The inkjet recording apparatus 1 according to the present embodiment described above includes the conveying unit 7 which attracts the sheet on the endless conveyance belt 21 and conveys the sheet, and the inkjet head 12 facing the conveyance belt 21, the conveyance belt 21 includes the slits 21S facing the end portions of the sheet S of a predetermined size in the width direction X crossing the conveyance direction Y, and the conveying unit 7 includes the absorber 31 for absorbing the ink in the space inside the conveyance belt 21. According to this configuration, it is possible to suppress the contamination and the variation in the speed of the conveyance belt 21 during the borderless printing.

According to the inkjet recording apparatus 1 according to the present embodiment, the length of the slits 21S is equal to or larger than the length of the sheet S of the predetermined size in the conveyance direction Y. According to this configuration, the contamination of the conveyance belt 21 can be suppressed over the entire area of the sheet S of a predetermined size in the conveyance direction Y.

According to the inkjet recording apparatus 1 according to the present embodiment, the slits 21S are continuous over a range longer than the length of the sheet S of the predetermined size in the conveyance direction Y. According to this configuration, as compared with the case where a plurality of the slits 21S shorter than the length of the sheet S of the predetermined size in the conveyance direction Y are arranged in the conveyance direction Y, the contamination of the conveyance belt 21 can be suppressed.

According to the inkjet recording apparatus 1 according to the present embodiment, the absorber 31 faces the slits 21S. According to this configuration, the ink passing through the slits 21S can be efficiently absorbed.

The inkjet recording apparatus 1 according to the present embodiment includes the detection device 32 for detecting the phase of the slits 21S when the conveyance belt 21 is traveled, and the registration roller 18 for feeding the sheet S to the conveyance belt 21 in accordance with the phase of the slits 21S. According to this configuration, the end portions of the sheet S in the width direction X can face the slits 21S.

According to the inkjet recording apparatus 1 according to the present embodiment, the absorber 31 is replaceable. According to this configuration, leakage of the ink from the absorber 31 can be prevented.

1. An inkjet recording apparatus comprising:
a conveying unit which attracts a sheet to an endless conveyance belt and conveys the sheet, and
an inkjet head facing the conveyance belt, wherein
the conveyance belt has slits facing end portions of the sheet of a predetermined size in a width direction crossing the conveyance direction, and
the conveying unit includes an absorber for absorbing ink in a space inside the conveyance belt.

2. The inkjet recording apparatus according to claim 1, wherein,
a length of the slit is equal to or larger than a length of the sheet of the predetermined size in the conveyance direction.

3. The inkjet recording apparatus according to claim 2, wherein,
the slits are continuous over a range longer than the length of the sheet of the predetermined size in the conveyance direction.

4. The inkjet recording apparatus according to claim 1, comprising:
a detection device which detects a phase of the slits when the conveyance belt is traveled, and
a registration roller which feeds the sheet to the conveyance belt in accordance with the phase of the slits.

5. The inkjet recording apparatus according to claim 1, wherein
the absorber faces the slits.

6. The inkjet recording apparatus according to claim 1, wherein
the absorber is replaceable.
